(19) United States
(12) Patent Application Publication
(10) Pub. No.: US 2017/0021541 A1
(43) Pub. Date: Jan. 26, 2017

(54) METHODS FOR COOLING MOLDS

(71) Applicants: Edward Smith, Sterling Heights, MI (US); Mikael Orsén, Chatham, NJ (US)

(72) Inventors: Edward Smith, Sterling Heights, MI (US); Mikael Orsén, Chatham, NJ (US)

(21) Appl. No.: 15/071,665

(22) Filed: Mar. 16, 2016

Related U.S. Application Data
(60) Provisional application No. 62/134,174, filed on Mar. 17, 2015.

(51) Int. Cl. B29C 45/73; B29C 33/04

(52) U.S. Cl. CPC B29C 45/7337; B29C 33/046

(57) ABSTRACT

Methods are provided for cooling a plastic part that has been produced in a mold. Carbon dioxide is fed through a capillary tube from a carbon dioxide source to the mold thereby providing cooling of the plastic part and avoiding hot spots in the plastic part prior to removal from the mold. The capillary tube is a smaller capillary tube located concentrically inside a larger capillary tube. Alternatively, the smaller capillary tube may extend from the end of the larger capillary tube telescopically thereby increasing the length of the capillary but also reducing its diameter as it progresses along its length.

### CROSS REFERENCE TO RELATED APPLICATIONS

This application claims priority from U.S. Provisional Patent Application 62/134,174 filed on Mar. 17, 2015.

### BACKGROUND OF THE INVENTION

During the production of plastic parts through molding operations, they are ejected and processed after they have cooled down to a certain temperature. The length of time that it takes for each part to cool accounts for the better part of the production cycle time. A cycle time that is too long will be detrimental to efficiency and profitability.

Further certain plastic parts experience a phenomenon known as “hot spots”. This phenomenon is when most of the plastic part cools down to the desired appropriate temperature but some small areas remain too hot. Removing the part with hot spots from the mold can produce deformity, flashing, oxidation and hazards for the operator.

Water can be used as a coolant but it has difficulty in reaching small areas. Further water also poses challenges. Small channels clog quickly due to mineral or biological content in the water which quickly eliminates its heat removal capability. In general water can also pose environmental and occupational hazards.

These difficulties can be overcome by feeding supercritical carbon dioxide beneath the surface of the mold where the hot spots occur.

### SUMMARY OF THE INVENTION

In one embodiment of the invention there is disclosed a method for cooling a mold used in production of plastic parts comprising feeding carbon dioxide to the mold through a capillary tube comprising a smaller, inner capillary tube located concentrically inside a larger, outer capillary tube.

In another embodiment of the invention, there is disclosed a method for delivering carbon dioxide to a mold used in the production of plastic parts comprising feeding carbon dioxide through a capillary tube comprising a smaller capillary tube located concentrically inside a larger capillary tube, wherein the smaller capillary tube extends telescopically from an end of the larger capillary tube.

In the alternative embodiment, rather than the at least one smaller capillary tube being present concentrically inside of a larger capillary tube, the smaller capillary tube will extend telescopically from the end of the larger capillary tube. This configuration can be set up such that a second, third, fourth or fifth smaller capillary tube can extend from the larger one preceding it such that a length of capillary tube would be provided that would stepwise get increasingly smaller in diameter.

For purposes of the present invention, telescopically means consisting of parts that slide one within another like the tubes of a jointed telescope and are thus capable of being extended or shortened. In this context, the smaller capillary tube is fitted into the larger capillary tube thereby creating a length of capillary tubing that diminishes in diameter. Once the two tubes are fitted together, they are permanently brazed together and cut to the proper lengths according to the needs of the operator.

Therefore, in one embodiment of the invention, a source of liquid carbon dioxide such as a cylinder supplies a one quarter inch tube to a solenoid. The solenoid in turn will feed a distributor which can contain numerous ports from which capillaries such as those described herein can extend and direct liquid carbon dioxide into the mold producing plastic parts. Typically the number of ports can be up to five but can be more as the operator so desires. It is important that the diameter of each fitting or connection along the length from the carbon dioxide source to the end of the capillary tube reduce in diameter at the fitting or connection. This ensures that the liquid carbon dioxide remains in the liquid state to properly deliver cooling to the spot in the mold where it is desired.

The carbon dioxide is typically liquid carbon dioxide and is fed to the mold at pressure of 800 to 900 pounds per square inch.

The plastic parts are selected from the group of thermoplastics consisting essentially of any thermoplastic material from polypropylene to polyether ether ketone (PEEK). The mold is typically cooled to a temperature which can vary widely depending upon the thermoplastic plastic used, but cool enough to ensure that the plastic parts are solid enough to remove from the mold.

The smaller capillary tube may be two or more tubes typically brazed together. The smaller capillary tube is fitted inside the mold in a manner such that it will deliver the liquid carbon dioxide to the hot spot or plastic piece that is in need of cooling.

The mold will typically be any type of mold such as an injection mold or a gas assist mold that is used in the production of thermoplastic parts and pieces. Typically, in injection molding, melted plastic is forced into a moldy cavity. Once cooled, the molded article can be removed. The cooling therefore is the reduction in temperature from when the plastic is in a melted state in the mold to when the mold can be removed and the now solid plastic part or piece can be removed without risking the structural integrity of the plastic part or piece.

The types of thermoplastic plastics that can be employed in an injection mold or other molding process for producing plastic parts or pieces are selected from the group consisting of all thermoplastics selected from the group consisting of Polypropylene (PP), Acrylonitrile-butadiene-styrene (ABS), Polycarbonate (PC), mix of PC and ABS Polyamide (PA), Polyether ether ketone (PEEK), Polyethylene (PE), Polyethylene terephthalate (PET), Polystyrene (PS), etc.

The carbon dioxide in the form of a liquid is fed through a capillary tube that is concentrically arranged inside of a larger capillary tube. The capillary tube is a thin tube made up of a material that can withstand contacting liquid carbon dioxide. These inner capillary tubes typically have an outer diameter of 0.062 inches (0.157 cm) and an inner diameter of approximately 0.032 inches (0.081 cm) and while the outer capillary tubes have diameters in similar ranges. The inner capillary tube can be more than one inner capillary tube fitting into the outer capillary tube so that a plurality of inner capillary tubes can fit into an outer capillary tube.

For purposes of the present invention, “concentrically” means that the one or more inner capillary tubes can fit within the outer capillary tube.

In practice then, the capillaries can be retrofitted into the mold assembly such as a steel mold thereby delivering the supercritical carbon dioxide beneath the surface of the mold where the hot spots occur. The efficient delivery of the carbon dioxide to the tip of the capillary enables reach into very thin sections of the mold to contact narrow parts of the plastic mold such as fillets or core pins. The cooling capacity of the carbon dioxide removes the heat swiftly and only gas evaporates out of the mold.

Alternatively, the concentric nature of the inner capillary tubes and the outer capillary tubes will allow for the smaller, inner capillary tubes to extend from the larger, outer capillary tubes in a telescopic fashion. In this manner, the overall capillary tube length can comprise the larger capillary tube feeding the smaller capillary tube and allowing for the smaller capillary tube to extend within the mold to provide cooling to smaller areas hot spots and plastic pieces to be cooled. This embodiment allows for a continuous length of capillary tube that gets smaller in diameter along the length of the tube. The inventors envision that up to five capillary tubes, each of decreasing diameter, can be positioned one after another wherein the smaller capillary tube will extend from the larger capillary tube and allow for the flow of liquid carbon dioxide throughout the length.

In a further embodiment of the invention, there is disclosed a method for cooling a mold used in the production of plastic parts comprising feeding carbon dioxide to the mold through a capillary tube having a constant wall size.

The benefits of the inventive design include a shorter cycle time for the production of plastic parts; elimination of the use of water as a cooling medium; better part quality; and more efficient cooling of plastic pieces, particularly in very thin fillets and core pins.

### BRIEF DESCRIPTION OF THE DRAWINGS

FIG. 1 is a schematic cross section showing a larger capillary tube with three smaller capillary tubes present therein.

FIG. 2 is a schematic showing a smaller capillary tube extending from a larger capillary tube.

### DETAILED DESCRIPTION OF THE INVENTION

In the method for cooling plastic parts according to the invention, liquid carbon dioxide is supplied at a pressure of 800 to 900 pounds per square inch (psi) to the capillaries. The supply of carbon dioxide may be from either liquid carbon dioxide cylinders with a siphon (dip) tube or from a bulk carbon dioxide tank depending upon the usage amounts. If the liquid carbon dioxide is from a bulk tank, a pressure boosting unit must be employed to increase the pressure to 800 to 900 psi. The liquid carbon dioxide will flow through stainless steel hoses to the cooling solenoid valves which are controlled by a 24V DC signal.

An advantage of the invention is in keeping the carbon dioxide in its liquid form from its source, whether cylinder, with siphon tube, Dewars, or full scale bulk tank to the delivery point. This is accomplished by keeping the cross section of the delivery system at its original cross section or reduced in size through its travel from the source of carbon dioxide to the end of the capillary tube. In the method of the present invention, up to five capillaries can be accommodated in a telescoping fashion from the carbon dioxide source to the mold. It is anticipated that a large number of capillaries can be so joined if the source volume is high enough.

To reach very remote or exceptionally small areas of the plastic part forming mold, a telescoping capillary was designed. This telescoping capillary comprises a combination of two capillary tubes, one located concentrically inside the other. For example, the first outer capillary tube has an outer diameter of 0.062 inches (0.157 cm) and an inner diameter of approximately 0.032 inches (0.081 cm). A second capillary tube having an outer diameter of 0.030 inches (0.076 cm) is brazed into place inside of the first capillary tube.

This design provides several advantages over using a single capillary. The tube in a tube design provides for strength of a larger capillary over most of the liquid carbon dioxide travel while providing the small diameter size to reach areas that a 0.062 inch capillary cannot thereby providing a robust delivery system. The large outer capillary size also provides adequate carbon dioxide volume for the majority of its travel and thereby minimizes the travel through the reduced diameter section of capillary.

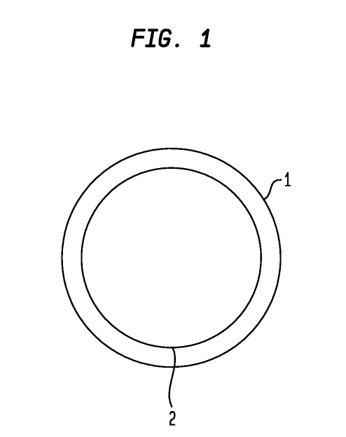

Turning to the drawing figures, in FIG. 1 a cross section of a larger capillary tube 1 is depicted with smaller capillary tube 2 present therein. As noted the larger capillary tube 1 concentrically encloses the smaller capillary tubes 2, 3 and 4. The smaller capillary tube 2 will be connected to the larger capillary tube by appropriate connection means such as welding, soldering or other metal joining technique.

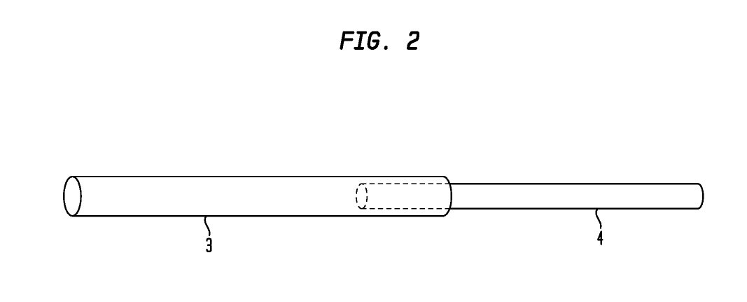

In FIG. 2, there is depicted the alternative embodiment whereby the smaller capillary tube extends from the end of the larger capillary tube, thereby providing the ability to feed liquid carbon dioxide to ever smaller locations. In this embodiment the larger capillary tube 3 will have the smaller capillary tube 4 telescopically extend from its end thereby lengthening the overall capillary tube length but also providing a smaller cross sectional diameter to allow the liquid carbon dioxide to flow to. The smaller capillary tube would be joined to the larger capillary tube by conventional means such as welding or soldering in the instance where stainless steel is employed as the capillary tube material.

In one embodiment of the invention, the system for providing cooling starts at a bulk tank typically with post tank pressurization or a cylinder with the carbon dioxide exiting the storage system at approximately 850 pounds per square inch (5.8×10⁶ Pascals). The exits are typically about 0.25 inches (0.63 cm) in diameter. The carbon dioxide travels via a carbon dioxide compliant hose to a solenoid. When the solenoid is activated, it allows the carbon dioxide to pass through the solenoid to a distribution manifold containing a plurality of distribution points.

The distribution points are where the capillaries are attached using a nut and ferrule or similar means. The capillary can be a single diameter for the length of the capillary. For smaller areas needing cooling, smaller capillaries can be located concentrically inside the larger capillary tube. The characterization of the system to provide cooling is that at every transition point namely bulk tank or cylinder to hose through the solenoid, and through the capillaries, the carbon dioxide stream remains the same diameter or reduces in diameter in order to keep the carbon dioxide in its liquid state until it has reached the final end point where it experiences its phase transition and the cooling required.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A method for cooling a mold used in production of plastic parts comprising feeding carbon dioxide to the mold through a capillary tube comprising a smaller capillary tube located concentrically inside a larger capillary tube.

2. The method as claimed in claim 1 wherein the mold is selected from the group consisting of an injection mold and a gas assist mold.

3. The method as claimed in claim 1 wherein the carbon dioxide is fed to the mold as a liquid at a pressure of 800 to 900 pounds per square inch.

4. The method as claimed in claim 1 wherein the plastic parts are selected from the group of thermoplastics consisting essentially of Polypropylene (PP), Acrylonitrile-butadiene-styrene (ABS), Polycarbonate (PC), mix of PC and ABS Polyamide (PA), Polyether ether ketone (PEEK), Polyethylene (PE), Polyethylene terephthalate (PET), and Polystyrene (PS).

5. The method as claimed in claim 1 wherein the smaller capillary tube is two or more smaller capillary tubes.

6. The method as claimed in claim 5 wherein five smaller capillary tubes are present in the larger capillary tube.

7. The method as claimed in claim 1 wherein the larger capillary tube has a diameter of 0.157 cm.

8. The method as claimed in claim 1 wherein the smaller capillary tube has a diameter of 0.081 cm.

9. The method as claimed in claim 1 wherein the larger capillary tube is fitted inside the mold.

10. The method as claimed in claim 1 wherein the smaller capillary tube extends from and end of the larger capillary tube.

11. A method for delivering carbon dioxide to a mold used in production of plastic parts comprising feeding carbon dioxide through a capillary tube comprising a smaller capillary tube located concentrically inside a larger capillary tube, wherein the smaller capillary tube extends telescopically from an end of the larger capillary tube.

12. The method as claimed in claim 11 wherein the mold is selected from the group consisting of an injection mold and a gas assist mold.

13. The method as claimed in claim 11 wherein the carbon dioxide is fed to the mold as a liquid at a pressure of 800 to 900 pounds per square inch.

14. The method as claimed in claim 11 wherein the plastic parts are selected from the group of thermoplastics consisting essentially of Polypropylene (PP), Acrylonitrile-butadiene-styrene (ABS), Polycarbonate (PC), mix of PC and ABS Polyamide (PA), Polyether ether ketone (PEEK), Polyethylene (PE), Polyethylene terephthalate (PET), and Polystyrene (PS).

15. The method as claimed in cairn 11 wherein the smaller capillary tube is two or more smaller capillary tubes.

16. The method as claimed in claim 15 wherein five smaller capillary tubes are present in the larger capillary tube.

17. The method as claimed in claim 11 wherein the larger capillary tube has a diameter of 0.157 cm.

18. The method as claimed in claim 11 wherein the smaller capillary tube has a diameter of 0.081 cm.

19. The method as claimed in claim 11 wherein the larger capillary tube is fitted inside the mold.
